(19) United States
(12) Patent Application Publication
(10) Pub. No.: US 2025/0356704 A1
(43) Pub. Date: Nov. 20, 2025

(54) TIME-BASED CODES FOR REMOTELY DEPLOYED LOCKS

(71) Applicant: RPH Engineering, LLC, Draper, UT (US)

(72) Inventor: Ryan Hyde, Lehi, UT (US)

(21) Appl. No.: 19/272,179

(22) Filed: Jul. 17, 2025

Related U.S. Application Data
(63) Continuation-in-part of application No. 18/919,521, filed on Oct. 18, 2024.
(60) Provisional application No. 63/544,705, filed on Oct. 18, 2023.
(60) Provisional application No. 63/559,724, filed on Feb. 29, 2024.

(51) Int. Cl. G07C 9/00

(52) U.S. Cl. CPC G07C 9/00309; G07C 2009/00428

(57) ABSTRACT

An access-control system comprises using an access management server, a lock, and multiple instances of time-based codes. A time-based code may be input to a lock by physical presses on a keypad; radio communication (Bluetooth, RFID, NFC, WiFi); a sound or audio signal; touch or vibration pattern; light pattern of intensity or contrast); and/or a sequence/pattern of temperature changes.

### CROSS-REFERENCE TO RELATED APPLICATIONS

This application is a continuation-in-part of and claims priority to U.S. nonprovisional patent application Ser. No. 18/919,521 filed on Oct. 18, 2024, titled “Time-based Codes for Remotely Deployed Locks, the first inventor of which is Ryan Hyde, and which is incorporated herein by reference in its entirety.

Application Ser. No. 18/919,521 claims priority to, and incorporates by reference in their respective entireties, the following two applications: (1) U.S. Provisional Patent Application No. 63/544,705, titled “TIME-BASED CODES FOR REMOTELY DEPLOYED LOCKS,” filed on Oct. 18, 2023, the first inventor of which is Ryan Hyde and (2) U.S. Provisional Patent Application No. 63/559,724, titled “TIME-BASED CODES FOR REMOTELY DEPLOYED LOCKS,” filed on Feb. 29, 2024, the first inventor of which is Ryan Hyde.

### BACKGROUND OF THE INVENTION

Many real-world situations benefit and/or could benefit from deployment of a set of shared and remotely deployed locks. Such situations include, e.g., factory/industrial settings, medical settings, rentals, and/or any other setting or environment in which multiple/changing personnel share access to one or more locks, and where the personnel and/or access rights assigned to such personnel change.

What is needed is an improved system and method for managing access rights and associated access credentials over multiple remotely deployed locks and multiple personnel.

### BRIEF SUMMARY OF THE INVENTION

An access-control system comprises using an access management server, a lock, and time-based codes. When a time-based code from the access management server does not match the time-based code computed by the lock, the lock may check temporally proximate time-based codes. Upon a determination that a temporally proximate time-based code matches, the lock may adjust its clock to re-sync with the access management server clock. Additionally, the lock may implement “soft matching” by determining that an input code is a match if it matches either a current or a proximate time-based code. Additionally, the access management server and lock may implement multiple parallel time-based code instances to facilitate additional functionality.

### BRIEF DESCRIPTION OF THE DRAWINGS

FIG. 1A illustrates an exemplary computing architecture for use in implementing the invention(s) disclosed herein.

FIG. 1B illustrates an alternative exemplary computing architecture for use in implementing the invention(s) disclosed herein.

FIG. 2 shows an exemplary scenario for configuring a lock.

FIG. 3 shows an exemplary scenario for configuring a lock.

FIG. 4 shows an exemplary re-sync event.

FIG. 5 shows details regarding an exemplary re-sync event.

FIG. 6 illustrates a flowchart of an exemplary method for re-syncing a clock.

FIG. 7 illustrates an exemplary computer system for performing steps as disclosed herein.

FIG. 8 shows a flowchart for an exemplary method as disclosed herein.

FIG. 9 shows a flowchart for an exemplary method as disclosed herein.

FIG. 10 shows a flowchart for an exemplary method as disclosed herein.

FIG. 11 shows a flowchart for an exemplary method as disclosed herein.

FIG. 12 shows a flowchart for an exemplary method as disclosed herein.

FIG. 13 shows a flowchart for an exemplary method as disclosed herein.

FIG. 14 shows a flowchart for an exemplary method as disclosed herein.

FIG. 15 shows a flowchart for an exemplary method as disclosed herein.

### DETAILED DESCRIPTION OF THE INVENTION

A system and method are disclosed for managing access rights and associated access credentials over multiple remotely deployed locks and over multiple/changing personnel.

An exemplary system may comprise a set of deployed locks. Each lock may comprise a mechanism for unlocking (and/or locking) based on a time-based key/access code. The key code may be presented to the lock through a physical interface on the lock (e.g., a key pad) or a wireless or proximately communication protocol/technology, e.g., Bluetooth, RFID, NFC, WiFi, wired communication, and/or any other data communication technology known in the art that may be used for communicating a key code to the lock. The device that communicates the key code to the lock may be an electronic device such as a smartphone, tablet, laptop, handheld electronic device, or any other analogous device known in the art having capabilities for transmitting (wired, wireless, or otherwise) a key code to the lock.

Time-based codes are known in the art. One implementation of time-based codes is often referred to using the acronym “TOTP”: Time-based one-time password. Time-based codes are often used as the second factor in a two-factor authentication scheme. For example, if a user attempting to access a restricted electronic system provides the correct password to the electronic system, the restricted electronic system may then prompt the user for a time-based code, e.g., a TOTP or other time-based authentication code. Upon receiving the correct time-based code from the user, the restricted electronic system may grant access to the system.

Although time-based codes may be implemented in several variants, all such variants are based on a core idea: At an initial point in time a user and a restricted electronic system share a seed code (“shared seed code”), and then in the future when the user requests access to the restricted electronic system, the user uses the shared seed code and the current time with a commonly known algorithm (e.g., a hash algorithm known to both the restricted electronic system and the user) to compute/manufacture a time-based code, which the user then presents to the restricted electronic system. The shared seed code may be referred to as an “asymmetric code.” The term “asymmetric” suggests that the shared seed code is unique to a device or group of devices. Because they are computed based on a current time or timer, the time-based code may be characterized as a sequence of codes, i.e., the sequence of codes computed at each time point.

The shared seed code may be shared in many ways. In some embodiments, the restricted electronic system may share the seed code with the user via QR code. The shared seed code may be shared in any other way known in the art for sharing a code, e.g., wireless data transmission, wired data transmission, and/or manual data input.

The current time may be obtained by the user and/or restricted electronic system in multiple ways. For example, the user and the restricted electronic system may sync their respective clocks at some point. Or the user and the restricted electronic system may each continually and/or periodically sync their respective clocks with an authoritative clock, e.g., such as how cell phones, websites, and other electronic devices sync their respective clock to an authoritative and/or universal clock. The user and/or restricted electronic system may also use a combination of the aforementioned and/or other methods to obtain the current time for computing a time-based key/access code. The user and restricted electronic system do not have to use an actual time clock. They may alternatively use any type of shared timekeeping system, e.g., a timer (e.g., incrementing every second) that begins at a predetermined start point at the moment the user and restricted electronic system sync their respective clocks/timers to each other.

The “current time” or “timer” may be implemented in several ways. Because a time-based code usually has a life-span, e.g., it is good for a period of time, the “current time” or “timer” may refer to the number of uniform-length time periods that have passed (possibly including the time period during which the time measure is taken) since a begin point in time. In a more general or abstract sense, the “current time” or “timer” may refer to the number of non-uniform-length time periods that have passed (possibly including the time period during which the time measure is taken) since a begin point in time. The schedule for time periods may be referred to as a “time-based code generation schedule.” Where time periods are uniform, a time-based code generation schedule is simple because it is merely an accumulation of uniform length time periods, e.g., the timer value “1” for a 30-second uniform-length time window may refer (assuming a timer/clock begin point of 0:00) to the time period 0:00.0-0:30.0 s, the timer value “2” may refer to the time period 0:30.1-1:00.0 s, the timer value “3” may refer to the time period 1:00.1-1:30.0 s, etc. For a time-based code generation schedule for non-uniform length time periods, the set of associations between timer values and time periods may be arbitrary, may be a pattern, or may be generated using an algorithm.

The restricted electronic system and the access management server must both know the time-based code generation schedule (which, again, is often as simple as each time period equals 30 seconds so the timer value gets incremented every 30 seconds) and must synchronize (or attempt as closely as possible) to synchronize their respective clocks.

Because the restricted electronic system knows both the shared seed code and the current time (or timer value), the restricted electronic system uses the commonly-known hash algorithm to compute a time-based code to compare to the time-based code presented by the user. If the two time-based codes match, then the restricted electronic system grants access to the user. Because the time-based codes are based on the current time (or some other common clock or timekeeping device/system), the generated time-based code regularly changes. The frequency (or chronological pattern/schedule) with which the time-based code changes may be set or adjusted depending on the characteristics of a specific application of time-based key codes. In many applications for two-factor authentication to restricted electronic systems, the time-based code changes every 30 seconds or every 60 seconds.

Time-based codes may be used to provide access to open (or close, or otherwise change obtain or change access to) a battery-powered lock. In one embodiment the lock may comprise no available data transmission capabilities other than a keypad for entering a code. Limiting data transmission technologies (e.g., WiFi, Bluetooth, NFC, RFID, etc.) may have at least the following benefits: (1) avoiding battery drain resulting from constant/periodic communication or pinging or similar communications and (2) avoiding the security vulnerabilities that are inherent with any communication protocol. By having no ports-wireless or hard-wired (e.g., USB)—security/hacking vulnerabilities associated with each such data communication protocol/technology are avoided.

An access management server may sync its clock with a lock's clock, or may otherwise become aware of or store the value of a lock's clock at a known point in time. In many embodiments, this may be simply setting the lock's clock to have the same value as the access management server's clock, or setting a clock/timer on the lock to zero at the same time a clock/timer on the access management server is set to zero. In one embodiment, this may be accomplished using a master code or syncing code for the lock. For example, when the master code or syncing code is input into the lock, e.g., through the lock's keypad, then the lock may determine that at the next press of any key with some time period such as 60 seconds, the lock should restart its clock timer. A user may simultaneously restart the associated clock/timer on the access management server through a web browser interface or other interface to the access management server that allows for pressing a button or otherwise inputting a direction to restart the associated clock/timer on the access management server. If both these actions are performed simultaneously, or substantially simultaneously (or otherwise using some known offset), then the clock/timer on the lock and the clock/timer on the access management server are synced with each other.

Syncing the clock/timer on the lock with the clock/timer on the access management server may comprise simultaneously indicating to both the lock and the access management server that each should set its clock/timer to zero. For the sake of clarity, the access management server may have many clocks/timers, e.g., for different locks and for many other reasons. When the access management server syncs a clock/timer with a clock/timer on the lock, the access management server is syncing the clock/timer associated with the specific lock. A lock may be identified by a serial number, unique identification number/code, or in other ways.

The lock described herein may be a remote (i.e., physically remote from the access management server) padlock, door lock, lockbox, or any other type of remotely deployed lock.

The lock and the access management server must also share a shared seed code and/or shared unique algorithm for computing a time-based key code based on a clock/timer. In one embodiment, in addition to syncing their respective clocks/timers, a lock and an access management server may also both know a shared seed code, and may each also know the same algorithm for computing a time-based access code based on the shared seed code and the current time from the synced clocks/timers. As described above, analogous systems are known and used for accessing restricted electronic systems. The shared seed code may be shared in multiple ways. In one embodiment, the shared seed code may be stored in the lock's firmware or other volatile or non-volatile on-lock storage system. The shared seed code may be provided by the lock manufacturer or other party with privileged access to the lock, and then the same shared seed code may also be provided to the lock management system.

For example, the manufacturer of the lock may store a shared seed code in the lock's firmware. When a company purchases the lock from the manufacturer, the manufacturer may provide the shared seed code to the company, e.g., printed on a sticker on the lock, or in paper documentation provided with the lock, or through an electronic or other communication in conjunction with purchase of the lock. In most embodiments the lock will also have a serial or identification number visible or otherwise readable on the outside of the lock. The company/purchaser may then input the lock's shared seed code into the company/purchaser's access management server, which may associate the shared seed code with the serial number of the lock or other lock identifier.

When a user desires to access/unlock the lock, the user may present/input an access code to the lock. The user may input the access code through a keypad. The user may receive the access code upon request from the access management server, which computes the access code as a time-based key code by inputting the shared seed code (shared with the lock), current time from the synced clock/timer (sync′d with the lock) into the algorithm that both the lock and access management server are using to compute time-based key codes. A typical process may be: (1) user requests access code for lock (identified by serial number or other unique identifier) from access management server; (2) access management server computes time-based key code based on clock/timer reading and shared seed code; (3) access management server provides computed time-based key code to user; (4) user inputs time-based key code (received from access management server) into lock; (5) lock uses commonly known algorithm to compute time-based key code based on shared seed code and current reading from lock's clock/timer; (6) lock compares its computed time-based key code with time-based key code input by user; (7) lock determines whether to grant access (e.g., unlock) based on comparison of lock's time-based key code with time-based key code input by user.

A slightly more concrete example may comprise the following: A user may have a smartphone or other electronic device capable of communicating with the access management server, e.g., over a cell phone or WiFi connection. The user may request an access code from the access management server. This request may be through an app on a user's smartphone, or through a web-browser interface to the access management server, or through a link provided to the user by email or another method. When the access management server receives the transmitted request to access the lock, the access management server determines whether access should be granted. This decision may be based in whole or in part on authentication/verification of the user's identity, access rights (role, access time, location, etc.). Upon a determination that the user should be granted access, the access management server may compute a time-based key code (using the shared seed code, time from the clock/timer, and known algorithm) and transmit the computer time-based key code to the user's smartphone or other electronic device. The user may view/read the received time-based key code and input this time-based key code into the lock through a key pad on the lock. The lock may then compute its own time-based key code (based on the shared seed code, time on the lock's clock/timer, and known algorithm) and compare with the time-based key code input by the user. If the two time-based key codes match, then the lock may allow access, e.g., by unlocking.

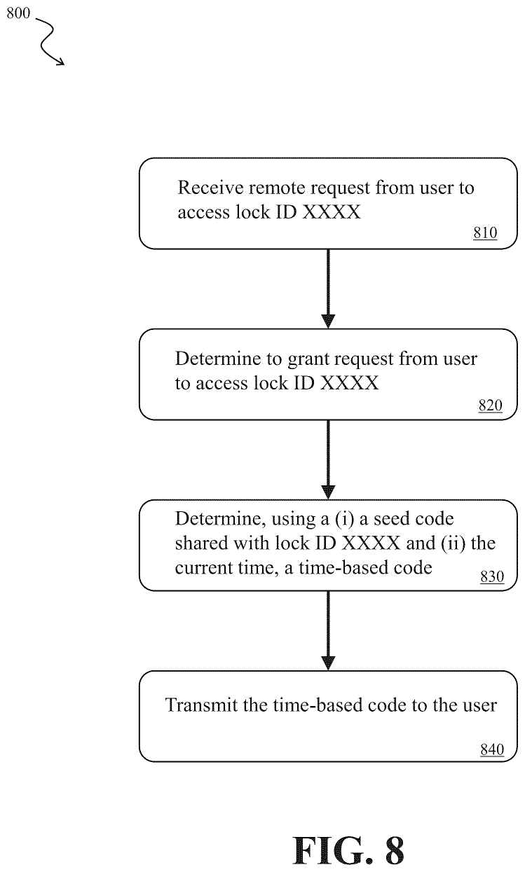

In one example, as shown in flowchart 800 in FIG. 8, the management server may perform the following steps. At Step 810, the management server may receive a remote request from a user to access lock ID XXXX (“XXXX” represents any lock id, e.g., a lock ID number, a lock serial number, etc.). At step 820, the management server may determine to grant the request from the user to access lock ID XXXX. At step 830, the management server may determine, using a (i) a seed code shared with lock ID XXXX and (ii) the current time, a time-based code. At step 840, the management server may transmit the time-based code to the user.

The frequency with which time-based key codes changes may be adjusted and/or tuned for specific applications. In some embodiments, the time-based key code may be recomputed every 60 seconds. If a user does not input the time-based key code sufficiently quickly into the lock, then the user may need to request a new time-based key code from the access management server.

The frequency with which the time-based key codes change is another parameter that must be known by each of the access management server and the lock. But it is more important for the lock to know this parameter so the lock can determine when a presented time-based key code is invalid as old. The access management server must also know the frequency parameter so it knows when to use a different time from the clock/timer for computing a time-based key code.

If the frequency is sufficiently granular, access privileges may be revoked almost instantaneously by simply not providing an updated time-based key code to a user.

In some embodiments, a lock may automatically close when an access time period has expired, or at some predetermined point after an access time period has expired.

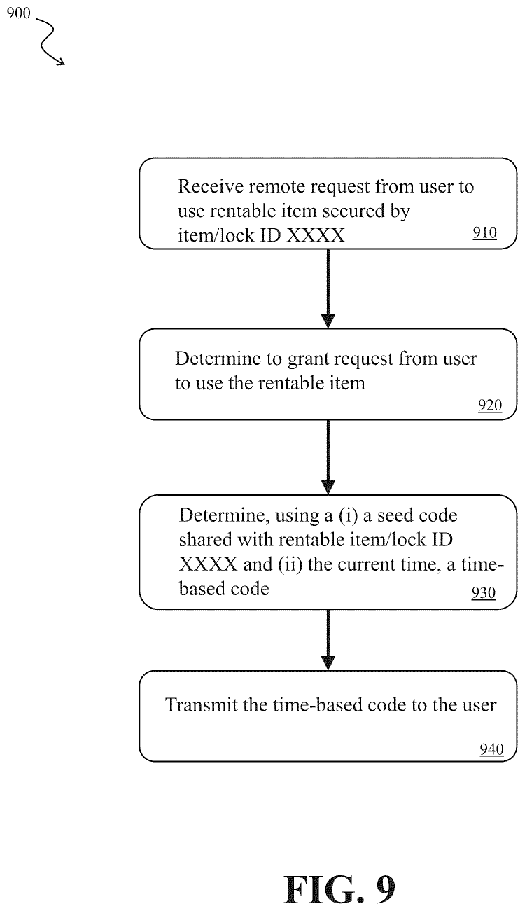

In some embodiments, e.g., where access means the ability to use something instead of merely opening a lock-such as using a rental bicycle—the rental bicycle may be programmed to shut off (e.g., applying a brake or otherwise becoming unusable) some period of time after an access code is entered. For example, a rental bike may show a QR code or Internet URL. When a potential renter/user uses their smartphone to follow the QR code link or Internet URL, the access management server may present an interface for renting the bicycle. When the user has satisfied the requirements for renting the bicycle, e.g., by paying a one-hour rental fee, the access management server may transmit to the user a time-based access code that the user may then input to the bicycle, thereby “unlocking” the bicycle. When the rental period expires after an hour, the bicycle may be programmed to no longer provide access. FIG. 9 shows a flowchart 900 for an exemplary method. At step 910, an access management server may receive a remote request from a user to use rentable item secured by item/lock ID XXXX. At step 920, the access management server may determine to grant the request from the user to use the rentable item. At step 930, the access management server may determine, using a (i) a seed code shared with rentable item/lock ID XXXX and (ii) the current time, a time-based code. At step 940, the access management server may transmit the time-based code to the user.

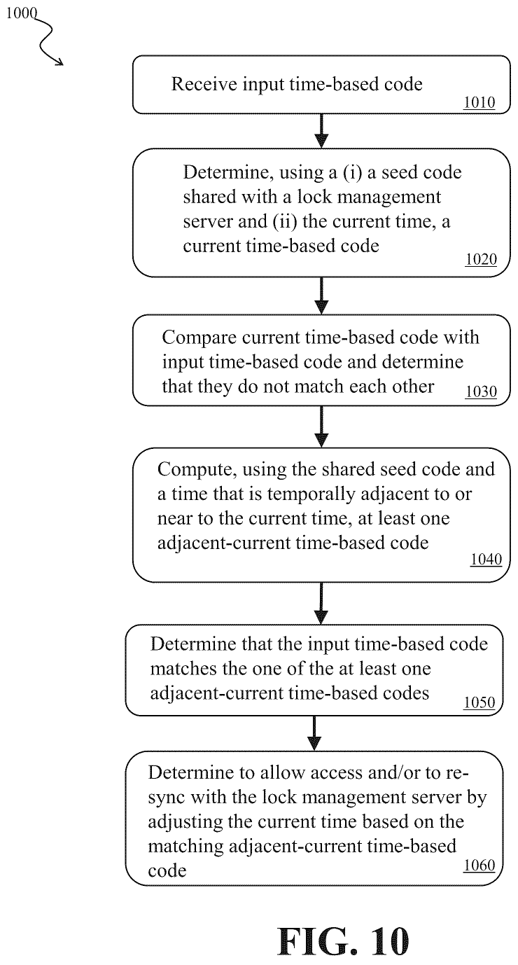

In some embodiments, an inputted time-based access code may be used to sync the lock's clock/timer with the associated clock/timer on the access management server. For example, if the two clock/timers have become unsynced, then a time-based access code from the access management server may appear to the lock to be expired or otherwise invalid. When presented with an invalid time-based access code, the lock may compute some number (e.g., two or three) time-based access codes using earlier times and later times from the lock's clock/timer. If any of these earlier/later time-based access codes match the time-based access code input by a user, then then lock may assume that the invalid time-based access code is not an attempt for unauthorized access but is instead merely reflective of a syncing issue, and may use this information to re-sync (as closely as possible) its clock/timer with the clock/timer on the access management server. FIG. 10 shows a flowchart for an exemplary method. At step 1010, a lock may receive an input time-based code. At step 1020, a lock may determine, using a (i) a seed code shared with an access management server and (ii) the current time (as stored by the lock), a current time-based code. At step 1030, the lock may compare the current time-based code with input time-based code and determine that they do not match each other. At step 1040, the lock may compute, using the shared seed code and a time that is temporally adjacent to or near to the current time, at least one adjacent-current time-based code. At step 1050, the lock may determine that the input time-based code matches the one of the at least one adjacent-current time-based codes. At step 1060, the lock may determine to allow access and/or to re-sync with the access management server by adjusting the current time based on the matching adjacent-current time-based code.

The lock may be configured/programmed to recognize one or more time-based access codes as master codes or other codes with specialized meaning and/or granting privileged or special use to a user. One such code may be a master code. A master code may be stored by the lock in firmware or in other volatile or non-volatile storage. When the master code is input to the lock, the lock may determine to grant access based on recognition of the input code as the master code.

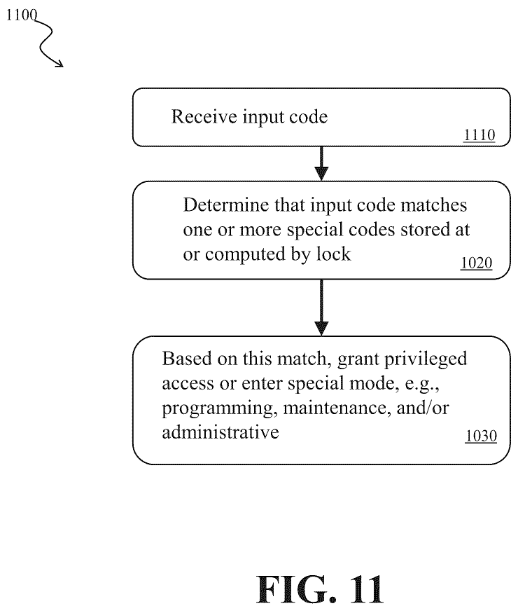

Other special codes may include an administrative or programming code. When the user presents to the lock a time-based code generated based on the special code, the lock may determine to allow special privileges to the user, e.g., inputting updated configuration information, inputting updated shared seed code information, inputting updated frequency for expiration of time-based codes, inputting clock syncing information, etc. FIG. 11 shows a flowchart 1100 for an exemplary method. At step 1110, a lock may receive an input code. At step 1120, the lock may determine that input code matches one or more special codes stored at or computed by the lock. At step 1130, the lock may, based on this match, grant privileged access or enter special mode, e.g., programming, maintenance, and/or administrative mode.

In one embodiment, the lock may change its behavior based on the value of an invalid input time-based key code. For example, the lock may be a medication lock box that has a different sub-box for different pill doses. The pills may be required to be taken in a specific order. If an expired time-based key code is inputted to the lock box, the lock box may determine to adjust its schedule for allowing access to offset to an earlier sub-box so that the pills are taken in order and not too close together in time.

In one embodiment, a lock may share multiple shared seed codes with one or multiple access management servers—each shared seed code being associated with a different behavior or set of behaviors by the lock. For example, a lock and an access management server may share six shared seed codes: one for 30-second frequency, one for 60-second frequency, one for 5-minute frequency, one for 10-minute frequency, one for 30-minute frequency, and one for 60-minute frequency. When a code is input into the lock, the lock may compute one or more of the six time-based key codes based on the six different shared seed codes and determine how to behave based on which (if any) of the codes matches. In one example, if the input code matches with the time-based key code computed based on the shared seed code for 60-minute frequency, then then lock may determine to use, for the next 60 minutes, only the shared seed code for the 60-minute frequency.

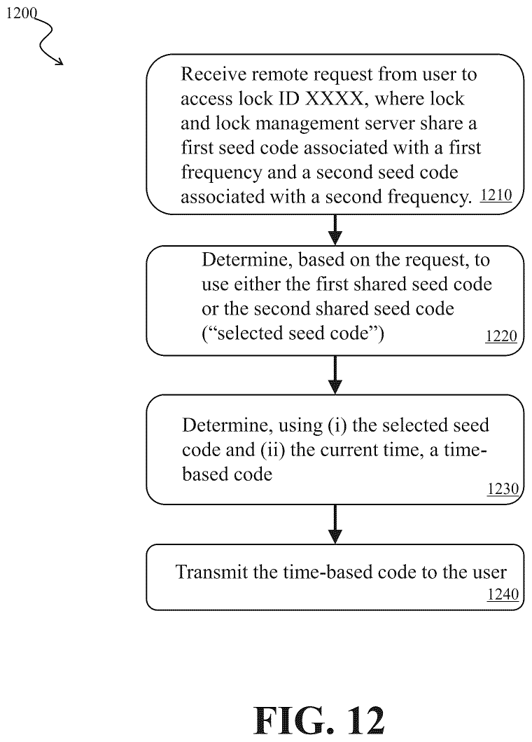

FIG. 12 shows a flowchart 1200 for an exemplary method from the perspective of an access management server. At step 1210, an access management server may receive a remote request from a user to access lock ID XXXX, where the lock and access management server share a first seed associated with a first frequency and a second seed code associated with a second frequency. At step 1220, the access management server may determine, based on the request, to use either the first shared seed code or the second shared seed code (“selected seed code”). At step 1230, the access management server may determine, using (i) the selected seed code and (ii) the current time, a time-based code. At step 1240, the access management server may transmit the time-based code to the user.

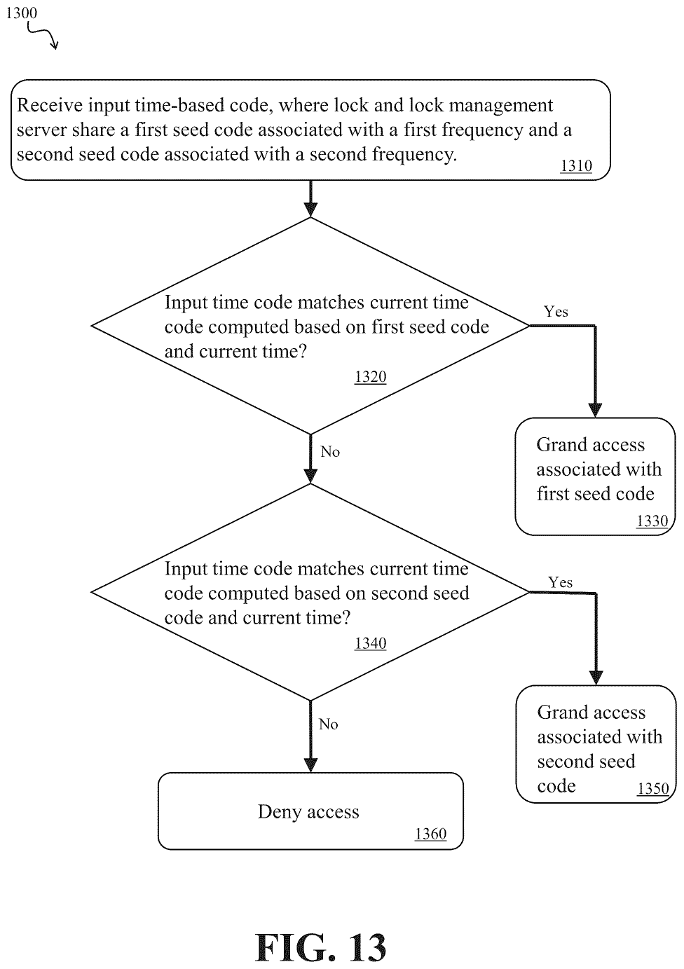

FIG. 13 shows a flowchart 1300 for an exemplary method from the perspective of a lock. At step 1310, the lock may receive an input time-based code, where the lock and the access management server share a first seed code associated with a first frequency and a second seed code associated with a second frequency. At step 1320, the lock may determine whether the input time code matches the current time code computed based on the first shared seed code and the current time. If yes, at step 1330 the lock may determine to grant access. If no, at step 1340 the lock may determine whether the input time code matches the current time code computed based on the second shared seed code and the current time. If yes, at step 1350 the lock may determine to grant access. If no, at step 1360 the lock may determine to deny access, or may continue to other actions, e.g., checking additional shared seed codes.

In one embodiment, a user may be going to access a lock at a location where the user will not be able to communicate with the access management server, e.g., a location without cell phone or WiFi service. In such a situation, the access management server may provide to the user's smartphone or other electronic device a set of time-based key codes that the access management server has computed based on a window of potential times at which it is anticipated that the user may attempt to access the lock.

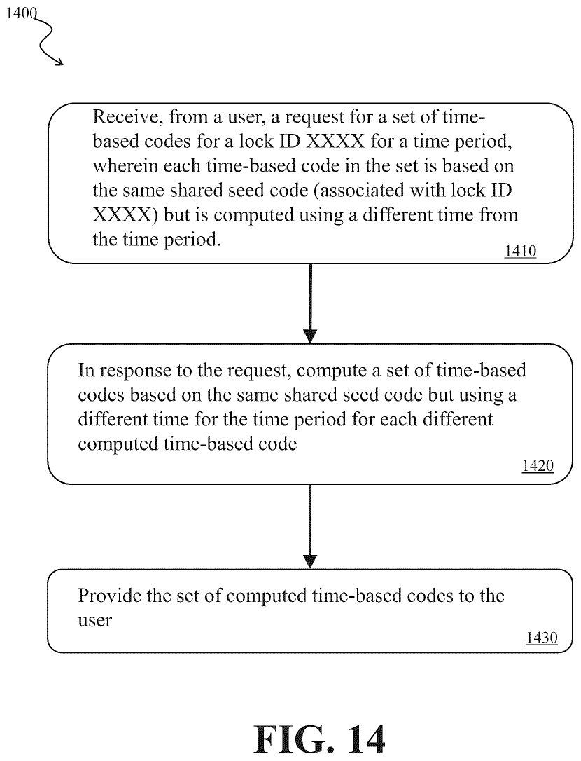

FIG. 14 shows a flowchart 1400 for an exemplary method from the perspective of an access management server. At step 1410, an access management server may receive, from a user, a request for a set of time-based codes for a lock ID XXXX for a time period, wherein each time-based code in the set is based on the same shared seed code (associated with lock ID XXXX) but is computed using a different time from the time period. At step 1420, the access management server may, in response to the request, compute a set of time-based codes based on the same shared seed code but using a different time for the time period for each different computed time-based code. At step 1430 the access management server may provide the set of computed time-based codes to the user.

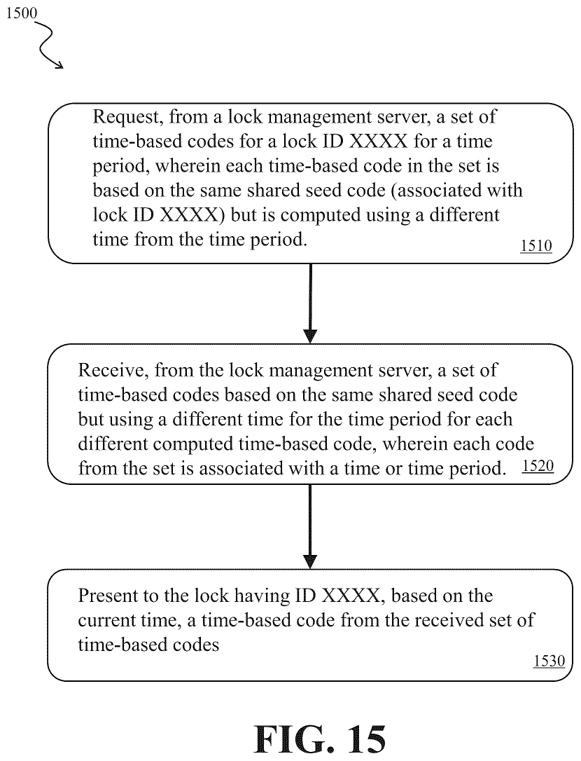

FIG. 15 shows a flowchart 1500 for an exemplary method from the perspective of a user or user device. At step 1510, the user may request, from an access management server, a set of time-based codes for a lock ID XXXX for a time period, wherein each time-based code in the set is based on the same shared seed code (associated with lock ID XXXX) but is computed using a different time from the time period. At step 1520, the user may receive, from the access management server, a set of time-based codes based on the same shared seed code but using a different time for the time period for each different computed time-based code, wherein each code from the set is associated with a time or time period. At step 1530, the user may present to the lock having ID XXXX, based on the current time, a time-based code from the received set of time-based codes.

In one embodiment, the access management server and the lock may share multiple shared seed codes. The set of multiple shared seed codes could be very small, e.g., two shared seed codes, all the way up to hundreds, thousands, hundreds of thousands, or possibly even millions of shared key codes. Having a set of shared key codes may facilitate several aspects of beneficial functionality, as described in the following paragraphs.

For example, unique shared key codes may be assigned to unique users.

Also, different shared seed codes may have different characteristics, and such characteristics may be commonly known by both the lock and the access management server. For example, a shared seed code may have an expiration, or a begin time and an end time, or multiple active periods. In this manner, an access management server may provide to a user a one-day shared-seed code to facilitate revocation of access privileges by simply not providing a new shared seed code. If both the lock and the access management server know that a shared seed code expires at 12:00 am MT on Dec. 5, 2023, then a user's attempt to use the shared seed code at a time later than 12:00 am MT on Dec. 5, 2023 will result in the lock not honoring the user's access request.

Assigning unique shared seed codes to users also facilitates the lock's logging of attempts to access or otherwise manipulate a lock by user (i.e., tracked by shared seed code). Such event log may be stored on the lock and transferred to the access management server either directly if/when a data transmission link is available, or through the device (e.g., smartphone) of a user or administrator.

In one embodiment, multiple shared seed codes (shared between the access management server and the lock) may be associated with non-overlapping time periods of which both the access management server and the lock may be aware. This scheme may allow for a paradigm in which only one shared seed code may be used to access the lock (or whatever the lock is restricting access to) at any particular time. This may be useful for, e.g., renting a property or piece of equipment. For example, a user on the beach may encounter a cruiser bike for rent that is locked up by a lock. The lock may have a QR code or URL on it. When the user uses their smartphone to access the QR code or URL, the user may be able to access a website or other remote service for renting the cruiser bike. The service for renting the cruiser bike (similar to an access management server as described herein above) may provide to the user's smartphone a time-based access code based on the shared seed code associated with the current time. When the user presents this time-based access code to the lock, the lock may identify the shared seed code associated with the current time and then use such shared seed code to generate a time-based access code for comparing/matching the time-based access code presented by the user's smartphone.

If multiple shared seed codes are associated with each time, but differ based on length, e.g., a shared seed code for a one-hour rental, a shared seed code for a two-hour rental, and a shared seed code for a three-hour rental, then this scheme could facilitate using time-based codes for rentals of different lengths. One of the benefits to using this scheme is that the lock does not need a real-time connection to the access management server, and instead needs only periodic updating with new shared seed code information. This would allow a system in which the lock did not have cellular, WiFi, or other wireless communication capabilities (as long as it included technology for receiving time-based key codes, e.g., from a user device such as a smartphone) or in which the lock was in a location where cellular or WiFi (or other communication technologies) were unavailable or unreliable/unstable.

Multiple shared seed codes could be used to implement other specialized or customized behavior. In general, using multiple shared seed codes—where the access management server and the lock each have an understanding of the meaning/significance associated with the different shared seed codes used at different points in time, in different orders, or in other patterns—may provide significant flexibility to the lock's behavior and control/communication by the access management server.

Because in most circumstances contemplated herein the lock will likely not know the identity of the user/device presenting the time-based code—but will instead know only the presented time-based code and information that was already stored at the lock prior to an interaction with the user/device, the lock may need to use multiple shared seed codes to generate multiple time-based codes to determine whether a presented time-based code should be honored as a match and also to determine what access should be granted or what other actions should be taken based on a conclusion that a presented time-based code is or is not a match. For example, in a simple exemplary embodiment in which the lock and the access management server each know two distinct shared seed codes, and the first shared seed code is assigned to User 1 and the second shared seed code is assigned to User 2, when presented with a time-based code the lock may generate two time-based codes for the matching operation: a first time-based code from the shared seed code associated with User 1, and a second time-based code from the shared seed code associated with User 2. The lock may grant access depending on which, if either, of the two generated time-based codes matches the presented code. Because the lock may need to generate and perform a matching operation on multiple time-based codes, the computational speed and storage capacity of the lock may limit the number of shared seed codes, the characteristics of the shared seed codes, or information associated with the shared seed codes.

The technologies and schemes described herein may be scaled to multiple locks, i.e., a system in which the access management server manages multiple locks similarly to the methods and systems described above for managing a single lock. Locks may be grouped, and/or characteristics of locks may be grouped, in many ways.

When scaling to multiple locks, it may be beneficial to use a unique shared seed code for only one lock, or one set or subset of locks. Using a shared seed code for only one lock, or a limited set of locks, avoids the problem where a hack of one lock results in a hack of multiple locks or of all locks.

For the sake of clarity, “access” or “lock” as disclosed and used herein should be understood to refer broadly to access-type operations: locking, unlocking, providing power, allowing mobility/movement, facilitating/enabling/preventing use, etc.

The disclosed technologies further relate to a new communication method that allows a LynkD lock and a LynkD cloud-based service to act as if they were connected even though they are not actually connected. This “pseudo” connection is achieved through an intelligent, initial synchronization between the lock and the service. This synchronization is persistent, thereby enabling the lock and the service to operate in unison to derive common results that enhance the functionality of the lock.

As a part of the synchronization, both the service and the lock are pre-programmed with code-generating algorithms that use synchronized clocks to concurrently generate the same codes at both the service and the lock. This synchronization persists throughout the life of the lock. Because of this persistent synchronization, the service is able to accurately derive (at approximately the same time) the same code that the lock generates, thereby mimicking a scenario in which the lock and the service are connected.

These generated codes are high-frequency codes in that they may be used any number of times within a given time window during which they are active. A user receives the code from the service and then presents the code at the lock. If that code is presented to the lock during the code's active time window, the lock will be unlocked. After the time window elapses, both the service and the lock concurrently generate a new code.

Validation/authentication of a user occurs through the service, not locally on the lock. Using the service, an administrator can validate individuals who are approved to open the lock. If a user is validated, the service may provide to the user a time-limited, high-frequency code. The lock validates only the code; the lock does not validate the user.

The disclosed locks may be powered by a battery or powered via the power grid. When the lock is powered by a battery, the LynkD technology significantly prolongs the battery's lifespan as compared to traditional battery-powered locks. Whereas traditional battery-powered locks often require new batteries on a monthly or yearly basis, LynkD technology may allow for a 15+year, maintenance-free, battery-powered lock. Specific details as to how this battery longevity is achieved are thoroughly outlined in this disclosure.

The following is a non-exhaustive list describing areas or use cases where the described technologies can be employed:

Protection of real property, including personal residences, rental properties, storage facilities, or any other non-moveable, lockable structure.

Protection of personal property, including vehicles, airplanes, boats, safes, or any other lockable, moveable structure.

Barrier protection, including doors, gates, garages, cabinets, containers, or any other enclosable, lockable structure.

Safety protection, including lock out tag out (LOTO) procedures, safes, or any other safety scenario involving a lock.

Workflow control, including controlling the scheduling of or adherence to procedures.

Asset scheduling control, including scheduling availability of an asset based on the configuration and expiration of the lock codes (e.g., multiple successive tenants of a rental property).

### Additional Embodiments

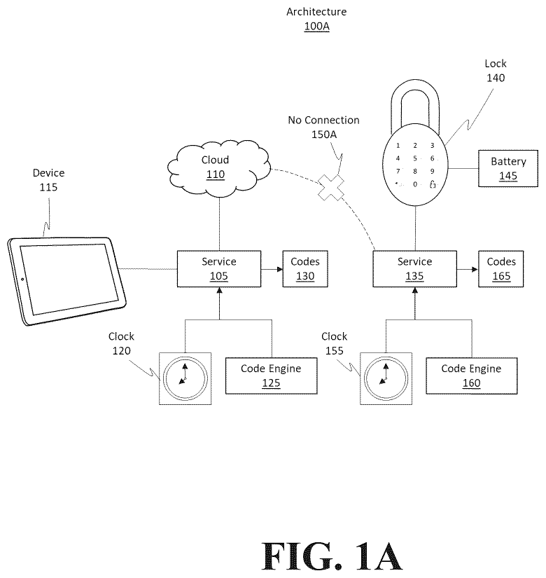

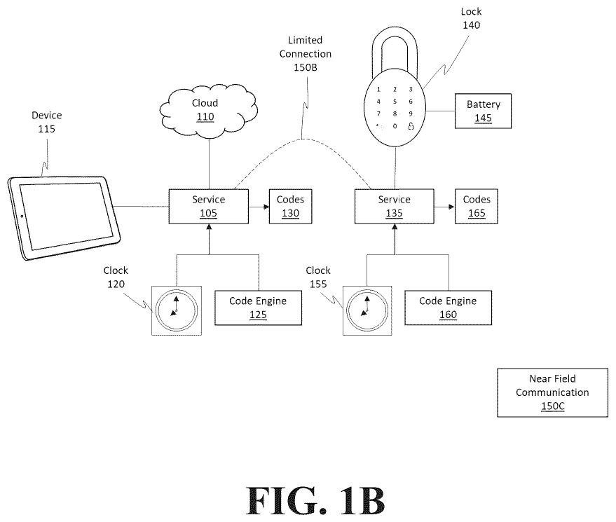

Attention will now be directed to FIG. 1A, which illustrates an example computing architecture 100A that can be used to perform the disclosed operations.

Architecture 100A includes a service 105, which can be implemented by any type of computing device. As used herein, the term “service” refers to an automated program that is tasked with performing different actions based on input or based on pre-defined criteria. In some cases, service 105 can be a deterministic service that operates fully given a set of inputs and without a randomization factor. In other cases, service 105 can be or can include a machine learning (ML) or artificial intelligence engine.

In some implementations, service 105 is a cloud service operating in a cloud 110 environment. In some implementations, service 105 is a local service operating on a local device, such as the device 115. In some implementations, service 105 is a hybrid service that includes a cloud component operating in cloud 110 and a local component operating on local device 115. These two components can communicate with one another.

Generally, service 105 is tasked with operating in conjunction with an internal clock 120 (aka “timer”) and a code engine 125. The clock 120 can be implemented in the manner described previously. For instance, the clock 120 can be a clock that tracks the universal time based on the Earth's rotation. Clock 120 can alternatively be a timer clock that counts the time from a designated setpoint or reset point.

Clock 120 operates in conjunction with the code engine 125 to produce the various different codes (e.g., time-based key codes) mentioned earlier. That is, code engine 125 includes a time-based algorithm that generates codes 130 based on the given time as determined by the clock 125.

FIG. 1A also shows service 135, which can be configured in the same or similar manner as service 105. In this scenario, however, service 135 is implemented on a lock 140 that includes a battery 145 and that may optionally be powered exclusively by battery 145. In some scenarios, lock 140 may be powered by a power grid. FIG. 1A also shows how service 135 is not connected (e.g., as shown by no connection 150A) to the cloud 110, nor is service 135 connected to service 105. Thus, in some implementations, service 135 is entirely without a network connection to another device.

Similar to service 105, service 135 includes a clock 155 and a code engine 160. Notably, clock 155 and code engine 160 are configured in the same manner as clock 120 and code engine 125, respectively. As a result of their same configuration, service 135 will generate a set of codes 165, where the codes 165 are the same as codes 130, even though they are generated on different devices. That is, inasmuch as the clocks 120 and 155 remain in sync with one another, the services 105 and 135 will generate the same set of codes at the same time, or substantially at the same time. Further details on this synchronization aspect will be provided later. As a quick introduction, it should be noted how the services 105 and 135 are not synchronized in the traditional manner in which their respective clocks portray the exact same time. Rather, there may be an amount of offset, though small (e.g., a value that is not zero, such as perhaps a number of milliseconds), that exists between the time tracked by the clock 120 and the time tracked by the clock 155. Further are provided herein below.

FIG. 1B shows another architecture 100B that is similar to the architecture 100A of FIG. 1A. The notable difference in FIG. 1B is that service 135 may, under certain limited circumstances, have a temporary connection to service 105, as shown by limited connection 150B. This time-limited connection may be implemented using any type of near field communication 150C protocol, such as Bluetooth or other related near field communication techniques. The disclosed embodiments limit the amount of time that this connection occurs so as to better preserve the battery life of the battery 145.

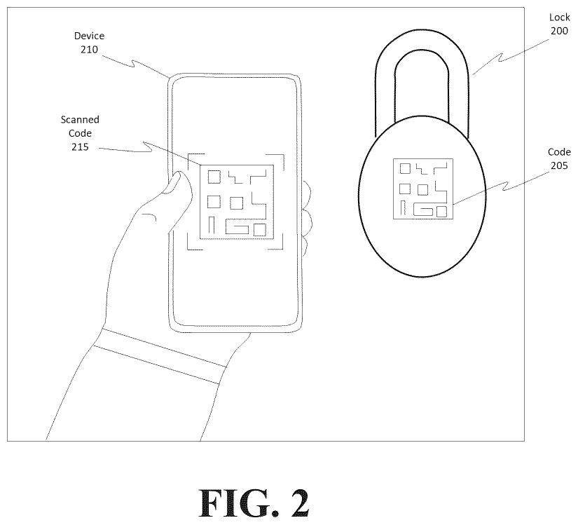

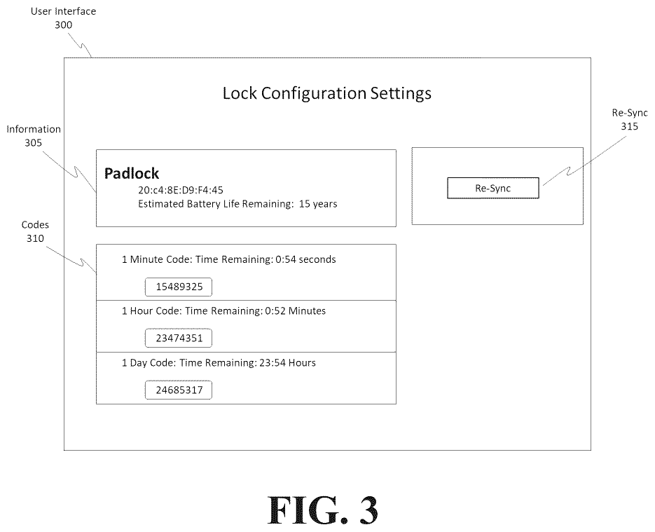

FIGS. 2 and 3 show example scenarios for configuring a lock. In particular, FIG. 2 shows an example lock 200, which is representative of lock 140 from FIGS. 1A and 1B. In this example scenario, a code 205 is associated with lock 200. Code 205 can be any type of code, including any type of QR code, bar code, alphanumeric code, and so on.

FIG. 2 also shows a device 210, which is representative of device 115 from FIGS. 1A and 1B. In this example scenario, device 210 is being used to scan the code 205, as shown by scanned code 215.

By scanning the code 205 of FIG. 2, the embodiments can cause a corresponding user interface to be surfaced, as shown by FIG. 3. In some implementations, user interface 300 is displayed and then the scanning event takes place. Regardless of the ordering of events, user interface 300 represents an interface that can be used to configure the settings of lock 200 of FIG. 2.

In the example shown in FIG. 3, user interface 300 includes information 305 about the lock. This information 300 can include any type of information, such as the serial number of the lock, the identifying username of the lock, the location where the lock is being used, the information about the person or entity that owns the lock, the firmware version or firmware information for the lock, and so on. In some scenarios, information 305 can also include an estimated amount of battery life that remains for the battery on the lock. In this example scenario, the estimated amount of remaining battery life is listed as 15 years.

In some scenarios, the information 305 may also specify one or more conditions or criteria that are to be met for a user to be provided with a set of codes for a lock. For instance, a number of successive steps or conditions can be outlined using the user interface 300. For a user to be granted codes, that user may be required to perform the conditions. Thus, user interface 300 can be used as a way to authenticate or validate users prior to granting them access to lock codes.

As another validation example, it may be the case that the user has to authenticate themself with the service 105 or the user interface 300 before being given codes. In such a scenario, user interface 300 can be used to perform facial recognition on the user. Additionally, or alternatively, user interface 300 can generate or access any of the following: global positioning system (GPS) coordinates, fingerprint data, authenticator application processors, question/challenge responses, and so on, in order to authenticate the user prior to the user being given codes.

As indicated generally above, the embodiments are able to perform multi-factor authentication. This type of authentication significantly reduces the hardware installation and maintenance requirements to have a truly secure access system that utilizes the processing power of network-connected devices (as opposed to the lock) as well as web-based processing tools, such as AI and so forth.

For example, traditional facial recognition in a building would be on a camera tied to a security system. If conditions were met, the installed security hardware recognizes a person and provides access. Using the disclosed techniques, a web-based AI for facial recognition can run authentication from the individual cell phone camera on someone seeking entrance, and the system may deliver the access codes only after the authentication has been performed. Other authentication data can be used, such as GPS location, fingerprint data, possession of the phone, etc., before codes are delivered. Combinations of this are also to be considered. For example, a user may be required to have the correct face, GPS location, and so forth prior to being given a code. All this can be run from a tablet computer that is not connected to the locking mechanism.

As another example, consider a scenario in which a user is presented a process or security question. The embodiments can expect a number of different valid responses and can choose to send a text message to only the authorized registered phone number. As another example, consider a scenario where a user scans a barcode to gain access on a door. The cloud-based service can ask that user to enter his/her name, badge number, student ID or any other challenge question. The service may then send the correct code to the authorized user.

As referenced herein above, one advantage of the disclosed embodiments relates to the ability to significantly prolong the battery life of a locking device. Whereas traditional battery-operated locks needed to have their batteries replaced on a frequent basis, the disclosed locks enable their batteries to operate for a prolonged period of time—e.g., often over 10 years, sometimes over 20 years. This battery life is achieved because the disclosed locks do not connect to other devices or networks, as was shown in FIG. 1A. Other power savings can be achieved by having the user pull, move, or release the lock's shackle or locking pin instead of using battery power to pull the shackle or locking pin. Aside from maintaining the internal clock and code engine, the lock's battery usage may be limited to moving the lock pin that allows movement of the shackle.

If, however, in limited instances, the lock comprises data communication capabilities and a connection is made, the connection may be time-limited and performed using a low power near field communication protocol. In most embodiments, the primary actions that consume power are limited to maintenance of the clock/timer and generation of a set of one or more codes (e.g., via the code engine), both of which actions consume only a very small amount of power. As a result, the battery life of the lock can be prolonged.

FIG. 3 also shows how the user interface 300 can display the codes 310 that are generated by the service 105 of FIG. 1A. It should be appreciated how these same codes are generated by the service 135 of FIG. 1A. Thus, both the device 115, which may be connected to the network, and the lock 140, which is not connected to the network, generate the same codes 310. It should also be noted how the duration of the codes can be set to any value. Thus, even though the example shown in FIG. 3 illustrates codes having a one-minute duration, a one-hour duration, or a one-day duration, different durations can be used. Often, a large number (e.g., more than 10, 20, 30, 40, 50, or sometimes even more than 100) different code instances or code durations are loaded into the lock's firmware, resulting in the lock comprising a set of pre-loaded codes. When the user desires to instantiate a new code, the user can use user interface 300 to generate a new code instance using one of the pre-loaded code instance options. Those code instances can then be accessed via the user interface 300.

As various examples, a code can have a one-second duration (or perhaps less than one second), a two-second duration, a three-second duration, a four-second duration, a five-second duration, a ten-second duration, a 30-second duration, a one-minute duration, a 10-minute duration, a one-hour duration, a one-day duration, a one-week duration, a one-month duration, a one-year duration, or more than a one-year duration. Indeed, codes can last for any amount of time, including less than one second or any amount of time more than one year. No limit is placed on the timing configurability of the codes.

In FIG. 3, different time-limited codes have been generated to suit different objectives. One type of code expires every 60 seconds, resulting in a new code being generated. That new code will then expire 60 seconds after its generation, and a new code will then be generated with a 60 second timespan. This one-minute code is illustrated in FIG. 3 with the following text: “1 Minute Code: Time Remaining: 0:54 seconds.” This type of code may be used in situations where a user is granted only a very limited period of time in which to unlock the lock. This code will remain active throughout the designated time window (e.g., 1 minute). Once the time window expires, a new code will be generated by the service(s) and will remain active for a new one-minute duration.

FIG. 3 shows another code that is configured to last for one hour, as shown by the code described with the following text: “1 Hour Code: Time Remaining: 0:52 Minutes.” This code will remain active throughout the designated time window. Once the time window expires (e.g., 1 hour), a new code will be generated by the service(s) and will remain active for a new one-hour duration.

To complete the example, FIG. 3 shows another code that is configured to last for one day (e.g., a 24-hour time period), as shown by the code described with the following text: “1 Day Code: Time Remaining: 23:54 Hours.” This code will remain active throughout the designated time window. Once the time window expires (e.g., one day), a new code will be generated by the service(s) and will remain active for a new one-day duration.

In some embodiments, the disclosed codes can be used any number of times within the associated time window. For instance, the one-minute code shown in FIG. 3 can be used any number of times within the 60 seconds that it remains active. After the 60 seconds expire, the code is no longer usable. Similarly, the one-hour code can be used any number of times within the 60-minute timeframe during which that code is active. After the hour elapses, the code is no longer usable. Thus, the one-hour code can be used 1, 2, 3, 4, 5, 6, 7, 8, 10, 100, 1,000, or more than 1,000 times within the one-hour time window.

Because the lock is not connected to a network, some embodiments load a set of codes (i.e., shared seed codes used for generating time-based codes) onto the lock at the time the firmware is loaded on the lock. Thus, the lock is pre-loaded with a number of code instances. The number of code instances may be large, e.g., as over 20, over 50, or over 100. As various examples, it may be the case that the lock is pre-loaded with five code instances, each having a timespan of one minute; and/or five code instances, each having a timespan of five minutes; and/or five code instances, each having a timespan of ten minutes; and/or five code instances, each having a timespan of 30 minutes; and/or five code instances, each having a timespan of one hour; and/or five code instances, each having a timespan of six hours, and so on. These codes are preloaded onto the lock.

User interface 300 may display the code instances that are currently in use. That is, user interface 300, in some instances, will not display all of the code instances that were pre-loaded onto the lock. Instead, user interface 300 will display only those codes that have been configured for use. When a user attempts to instantiate a new code, user interface 300 can present a drop-down option to the user to enable the user to select one of the available code instances that were pre-loaded onto the lock.

### Re-Synchronization

FIG. 3 also shows an option to trigger a re-synchronization between the clock 120 of device 115 shown in FIG. 1A and the clock 155 of lock 140. Recall, these clocks 120 and 155 do not (at least typically) communicate with one another nor does clock 155 communicate with a central source of authority (e.g., an atomic clock). It may be the case, however, that clock 120 does communicate with the central source of authority.

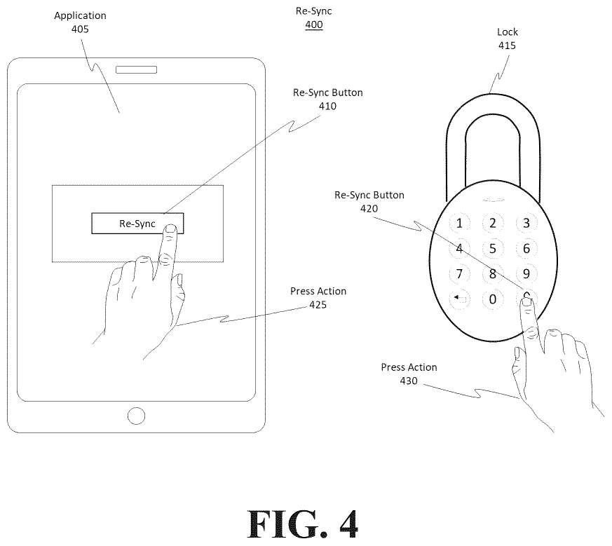

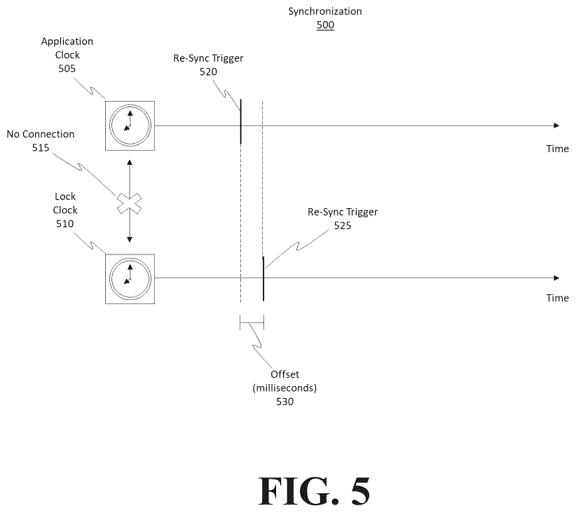

User interface 300 can be used to facilitate a re-synchronization event between the two different clocks. FIGS. 4 and 5 provide further detail.

FIG. 4 shows a re-sync 400 event involving an application 405, which corresponds to the service 105 of FIG. 1A and which corresponds to the user interface 300 of FIG. 3. Application 405 shows the re-sync button 410, which is representative of the re-sync 315 option shown in FIG. 3.

FIG. 4 also shows a lock 415, which corresponds to the locks described herein. Lock 415 includes a number of selectable buttons, including a re-sync button 420. To trigger the re-sync operation, a user will follow the instructions provided by application 405. Typically, these instructions include instructions to enter a specific code on lock 415. The instructions often further include instructions to press re-sync button 410, as shown by the press action 425. Within a threshold time period, the instructions will also instruct the user to press re-sync button 420 on the lock 415, as shown by press action 430. By pressing re-sync button 410 and re-sync button 420, the clocks on both services (e.g., service 105 and service 135 of FIG. 1A) will be caused to re-start (or to otherwise note or store the point in time of the re-syncing or a counter associated with the re-syncing). For instance, supposing the clocks are timers, those clocks will be reset so their new starting value is now 0.

FIG. 5 provides some additional description regarding the synchronization process, as shown by synchronization 500. As mentioned briefly earlier, the disclosed “synchronization” or “re-sync” may result in a slight offset between the two clocks because of the manual synchronization actions that occur, as was described in FIG. 4.

To illustrate, FIG. 5 shows an application clock 505, which is representative of clock 120 from FIG. 1A. FIG. 5 further shows a lock clock 510, which is representative of the clock 155. As was mentioned previously, these two clocks do not (at least typically) communicate with one another, as shown by the no connection 515 label.

In accordance with the disclosed principles, the synchronization 500 event involves initially triggering a re-sync on the application clock 505, such as by pressing the re-sync button 410 in FIG. 4, as shown by re-sync trigger 520. The user is then also tasked with triggering a re-sync on the lock clock 510, such as by pressing re-sync button 420 in FIG. 4, as shown by re-sync trigger 525. Because the two clocks do not communicate with one another and because the manual press of those re-sync buttons do not happen at the immediate same time, an offset 530 will purposefully exist between the timing on application clock 505 and the timing on lock clock 515. Typically, offset 530 is quite small, such as a number of milliseconds. As various examples, offset 530 may have a value somewhere between about 1 millisecond to about 100 milliseconds. Although the offset 530 is small, the offset 530 does exist.

The disclosed embodiments allow this re-synchronization to occur as desired. Typically, re-synchronization is performed very rarely and/or is necessary only rarely. Because the clocks and the processors executing those clocks utilize different hardware, it may be the case that one clock lags behind the other. Over time, the difference between the clocks may grow, causing the offset 530 to progressively (e.g., over numerous years) grow. If the offset 530 becomes noticeable, then a re-sync event may occur.

One way in which the offset 530 can become noticeable may deal with codes that are active during a very small time window, such as a one-minute code, a 30-second code, a 10-second code, a five-second code, or even a one-second code. Using the one-second code duration as an example, if offset 530 has progressively grown to 0.5 seconds, then that offset may now impact the ability to enter the code within a given timespan or window. If such a scenario occurs, then the user may recognize or may otherwise be alerted that a re-sync event is to occur.

In some scenarios, in an effort to preemptively address the growing offset situations, some embodiments may retain previously generated codes (e.g., one, two, or more than two previous sets of codes) and may preemptively generate the next set of codes (or the next one, two, or more than two next set of codes). The embodiments can compare the entered code against the currently active codes. If these codes do not match, then the embodiments can optionally compare the entered code against the previously generated codes and/or the preemptively generated next set of codes to determine whether the entered code matches any of these codes. If a match exists, then it is likely that the offset 530 has reached a level where it is now disrupting the process, and a re-sync event should be performed.

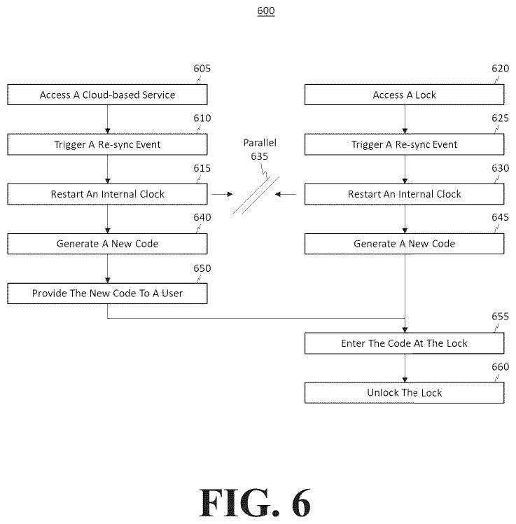

Attention will now be directed to FIG. 6, which illustrates a flowchart of an example method 600 for re-syncing a clock on a network-enabled device (e.g., device 115 of FIG. 1A) and a network-disabled device (e.g., lock 140). The actions performed on the lefthand column are performed at device 115 and at least some of which are performed using service 105. The actions performed on the righthand column are performed at lock 140 and at least some of which are performed using service 135.

Method 600 includes an act (act 605) of accessing a cloud-based service. One example of this service is service 105 from FIG. 1A. Service 105 can be accessed via device 115 and via the applications mentioned herein.

Act 610 includes triggering a re-sync event at the cloud-based service. Triggering the re-sync event on service 105 is performed as illustrated in FIG. 4. In particular, the re-sync event on service 105 is performed by selecting the re-sync button 410.

Act 615 then includes restarting an internal clock associated with service 105. For instance, application clock 505 of FIG. 5 is restarted, with its time now starting at the value 0 at the instant in time corresponding with re-sync trigger 520.

FIG. 6 also shows a number of acts that are performed in parallel with acts 605, 610, and 615. Stated differently, acts 605, 610, and 615 are performed during a first time period or time window, and acts 620, 625, and 630 are performed during a second time period or window. Notably, at least a portion of the second time window at least partially overlaps at least a portion of the first time window.

Act 620 includes accessing a lock. Lock 415 from FIG. 4 is illustrative of this lock.

Act 625 includes triggering a re-sync event at the lock. Triggering the re-sync event on the lock is performed as illustrated in FIG. 4. In particular, the re-sync event on lock 415 is performed by selecting the re-sync button 430. Often, the selection of the re-sync button 430 is preceded by the user entering another code, such as perhaps a master code or a code designed to facilitate the re-synchronization.

Act 630 then includes restarting an internal clock associated with lock 415. For instance, the lock clock 510 of FIG. 5 is restarted, with its time now starting at the value 0 at the instant in time corresponding with the re-sync trigger 525.

Notice, acts 615 and 630 are explicitly shown as occurring in parallel 635 with one another. As mentioned previously, the parallel performance of these acts does not necessarily mean that they are performed at the exact same time; rather, these acts are performed within a small offset or range of time relative to one another. As mentioned previously, the offset may be less than about 100 milliseconds. Thus, it will be appreciated that this is often not an absolute or perfect synchronization.

Act 640 then includes the cloud-based service generating a new code based on the re-synchronized clock. This new code is generated using the code engine mentioned previously, and the code engine relies on the internal clock to determine what code to generate.

Concurrently with act 640, act 645 includes the lock also generating a new code. By way of further detail, one of acts 640 or 645 will occur, followed by the offset time period, which is then followed by the other of acts 640 or 645. Thus, “concurrently” does not necessarily mean that acts 640 and 645 happen at the exact same time; rather, they happen within a threshold time period of each other, where the threshold is based on the offset. The generated code will be the same code as the one that was generated by the service. Furthermore, these codes are generated for use during a specified time window, such as a one-minute time window, a one-hour time window, a one-day time window, and so on. As mentioned previously, the generated code can be used any number of times within the given time window.

Act 650 then includes providing the new code to a user. The code can be provided to the user via the user interface 300 or by some other manner, such as via a text message, email message, voice message, or any other technique for delivering a code. The user may then use the code at the lock to unlock the lock.

To illustrate, act 655 includes the user entering the code at the lock. Act 660 then includes unlocking the lock in response to the correct code being entered at the lock during the time window in which the code is active.

### Additional Details

In some embodiments, the lock may further be equipped with one or more LEDs or speakers. These LEDs and/or speakers can operate as output (e.g., by providing a light-up pattern, flashing/blinking pattern, illumination strength pattern, color pattern, or a combination of some or all of these, etc.) for the lock to inform the user of certain actions, such as when a re-sync event is to occur or when a message is to be delivered to the cloud-based service. In some scenarios, the LEDs and speakers can also be used to provide information to assist the user in configuring the lock. For instance, previously it was mentioned how a QR code can be scanned to trigger the display of configuration information for the lock. In some cases, the lock can display an LED pattern or an audio output, and those outputs can be used to trigger the display of the configuration page.

It should be noted how the disclosed locks can be used for any purpose. Example usages include, but certainly are not limited to, any type of asset protection, such as protecting a rental property, house, equipment, and so on. The disclosed locks and service can optionally be owned by the same person, and that person can use the disclosed principles to provide access to an asset to other individuals. Also, while a majority of this disclosure focused on a scenario where the code entered at the lock was an alphanumeric code, any type of symbol can be used as a code, not just numbers and letters.

### Workflow/Procedure Enforcement

The disclosed principles can also be used to govern or control a workflow of events or a procedure. For instance, through the configuration of the codes and their corresponding time windows, the embodiments can operate to control the flow of certain events. In one example scenario, a first user may be provided with a first code that is active during a first time period, and a second user may be provided with a second code that is active during a second, subsequent time period. During the first time period, the second user will not be able to use his/her codes. Similarly, during the second time period, the first user will not be able to use his/her codes. In this manner, the ordering of certain events can be controlled through the disclosed principles.

Related to the ordering of events, the disclosed principles can also be used in a safety scenario, such as a lock out tag out (LOTO) scenario. With traditional LOTO scenarios, an individual user would place his/her lock on an asset and then perform work on that asset. While the lock was in place, no other individual could use the asset because it was “locked out.” The disclosed locks can also be used in a LOTO scenario to control access to an asset for safety reasons.

Running multiple code instances may facilitate LOTO. For example, a LOTO lock and a Management Server may both be running two code instances (each, e.g., 30-second time periods) for the LOTO lock. When a worker requests from the Management Server a code to access/open the lock, the Management Server may provide the first code, and the LOTO lock may be programmed so that when it is opened/access with the first code, it cannot be opened/accessed again except with the second code. And the Management Server may be programmed/configured to not provide the second code to anyone until some notification or indication has been received, or possibly until some time period has passed. Alternatively, the Management Server may determine that once it has provided to a first user a code from the first code series instance (based on a shared seed code), it will not provide a code for the same lock/device to any other user until the Management Server has received an indication or notification that it is safe or otherwise acceptable to begin providing codes for that lock/device.

In one embodiment, a facility may have a set of LOTO locks. When a user obtains a LOTO lock, the user Management Server may associate that LOTO lock with that user and may provide TOTP(s) for that lock/device to only that user.

### Parallel/Multiple Time-Based Code Instances

As another example, consider a scenario where the lock and the cloud-based service each have three 30-minute frequency codes running. If the cloud-based service provides the first code, it may result in the provisioning of a lower or level-1 access for a user (e.g., consider a rental bike that can go only 10 mph and/or that may move only 3 miles from origin). Use of a second code may result in the provisioning of a higher or level-2 access for the user (e.g., the rental bike can now go up to 15 mph and/or it may be moved up to 5 miles from its origin). Use of third code may result in the provisioning of an even higher or level-3 access for the user (e.g., the rental bike can now go up to 20 mph and/or it may move up to 7 miles from its origin).

Use of multiple parallel time-based code series instances could be used in many ways to communicate information from the Management Server to a lock/device. Depending on the computing capacities of the lock/device, the number of parallel time-based code series instances could range from two up to tens, hundreds, thousands, or more parallel instances of time-based code series. The limiting factor will usually be the computing capacities of the lock/device and not the Management Server, but it is possible that the Management Server could have computing capacities/capabilities that would limit the number of parallel time-based code series instances that could be running on the Management Server and on the lock/device.

For example, the selection of which time-based code series instance to use could communicate to the lock/device user identity or some other behavior modification (e.g., lock-down time, access level, etc.) that the lock/device should implement and/or possibly log. For example, a different time-based code series instance could be assigned to each user, different projects, different lock/device behaviors, etc.

Disclosures herein regarding syncing, re-syncing, and other management functions easily scale to multiple parallel instances of time-based code series.

Data Communication from Management Server to Lock

Recall, the cloud-based service and the service running on the lock typically do not communicate with one another. That being said, it is possible to still pass information from one service to the other service. As one example, the cloud-based service can optionally generate a code in which one or more digits are so-called “dummy digits.” These digits can correspond to predefined keys or codes. When entered at the lock, the lock may receive those keys and interpret them accordingly. An example will be helpful.

Consider a scenario where the cloud-based service generates the following code: 1113111. In this scenario, a code that includes three successive ones, a single value (or perhaps a multi-digit value), and then three more successive ones can optionally operate as a message for the lock. Here, the value “3” may correspond to a specific predefined message that was loaded on the lock when its firmware was loaded. As one example, the value “3” may correspond to the following message: “go on lockdown mode for the next 1,000 clock cycles.” A different value may correspond to a different message. When the code 1113111 is entered at the lock, the service (e.g., the firmware) on the lock can interpret the message accordingly and can go on lockdown for the next 1,000 clock cycles.

In another embodiment, the lock/device may respond to an inputted code as if the code is not a match (e.g., by a flashing LED, etc.) even though it is a match, and the next code, if received within some time period, could be used for data communication from the Management Server to the lock/device. In a similar embodiment, the selection of which time-based code series instance to use from multiple parallel instances of time-based code series could indicate to the lock/device that it should behave/respond to presentation of the code as a no-match-even if it is—and that when a user requests/receives another code from the Management Server, that the lock/device should indicate a match to the user but should treat the second code as information from the Management Server to the lock/device.

### Lock-to-Management-Server Communication

In some scenarios, particularly those where the lock includes a speaker, display, or LEDs (or any device or component for outputting information, preferably in a low power manner), those output devices (e.g., the LEDs or speakers) can be used to relay a message to the user or back to the cloud-based service. For instance, the LEDs can be lit in accordance with a predefined pattern, where the pattern reflects a particular predefined message. LEDs may transmit or indicate information through a light-up pattern, flashing/blinking pattern, illumination intensity pattern, color pattern, a combination of some or all of these, etc. Thus, messages can optionally be relayed back and forth between the cloud-based service and the lock service even though those two services are not connected to one another.

In some implementations, the lock may have a display screen that also displays information that can be passed to the cloud-based service.

As another example, the lock may have a QR code as well as the LEDs and/or the speaker. The user can use his/her phone to not only capture the QR code but also the display pattern of the LEDs or the audio produced by the speakers or the message on the display. This capturing can be performed using application 405 of FIG. 4 or user interface 300 of FIG. 3. In some implementations, the user interface includes a special web page or application feature that can simultaneously capture the entire QR code as well as the LED configuration and/or the sound. This data capture can then be processed, e.g., on a user device, Management Server, etc., to determine the output/meaning provided by the lock. Such processing may be image recognition, machine learning, object identification, etc. Additional captured information may include image, video, audio, temperature, etc. This information may be used by the Management Server to determine the state of the lock/device and/or state of the environment or location of the lock/device.

In some implementations, the device 115 of FIG. 1A can also capture any number of images, videos, sounds, temperatures, or other sensor data. That data can then be processed by service 105 to decode into information or to gather information about the state/environment of the lock.

### Pill Box Management

As another example, consider a scenario in which the lock controls access to different compartments or containers, such as a scenario involving a pill box and the lock controls independent access to the pills in the box or to one or more compartments or containers, each of which may potentially contain one or more pills. In one example scenario, the pill box may include a QR code. When the device 115 captures an image of the QR code on the pill box, device 115 can also capture the display pattern of the LEDs or some other type of indication on the pill box, or an image of the pill box that can be processed using image processing techniques. These LEDs (or the captured images or other captured data) can optionally indicate which pills have been consumed and which have not yet been consumed, e.g., by being illuminated if a particular compartment has been opened or illuminating in a manner to indicate when a compartment was opened. Sometimes, a user may consume pills in a delayed manner. If a set of pills were just recently consumed and the next set is not supposed to be consumed for a period of time, the LEDs can be used to operate as a message to indicate that even though an original time period at which the next group of pills were to be consumed occurs, those pills should not yet be consumed because the threshold amount of time has not elapsed since the last group of pills were consumed. Thus, the LEDs can be used to help control the process flow, and a particular code for the lock may be rendered non-functional or non-usable until such time as the threshold time period has elapsed.

### User Groupings

In some scenarios, different user groupings can also be defined. For instance, it may be the case that a group of multiple users are provided with the same code to use, and this code is usable during a defined time period or window. Any of those users can use the code that has been provided (it may be the same code as the other users) to gain access to the lock. In some scenarios, multiple users may belong to the same group, but each user may be provided with a distinct code. All of the codes for the group, however, may have the same duration. Thus, the expiration may equally apply to all of the codes for the group. If a group scenario is being used, then the user interface 300 of FIG. 3 can be used to configure the settings for that group of users. Such configuration settings may include the duration that their codes will last and/or any other group-level access features.

Use of time-based codes makes it very easy for a Management Server to change user groupings or other management lever access issues. No cards need to be collected from users. No reconfiguration of locks needs to be done. Instead, the Management Server merely changes which codes are provided at which times to users.

### Form Factor

It should be noted how the disclosed “locks” may have any form factor, without limit. In some cases, the locks are implemented as a padlock. In some cases, the locks are implemented as a keypad, touch screen, or some other touchable unit. Regardless of how it is implemented, it is typically the case that the lock is battery-powered. Of course, some forms of the lock can be powered via the power grid or powered via a form other than a battery. Other examples of locks include, but are not limited to, door locks, lockout/tagout locks, rental locks, padlocks, lock boxes, vending machines, and so on.

For example, a time-based-code-series-based vending machine could be unconnected (or have/use limited connectivity) to the Internet or other network. By scanning a QR code a user may pay for an item, receive a time-based code TOTP to input into the vending machine from the Management Server, and then input the time-based code into the vending machine. The vending machine will respond by vending the purchased item. The app that recognizes the QR code could also capture one or more images or video to communicate to the Management Server the state of the vending machine, e.g., the amount of product and/or other issues relating to the state of the vending machine. This embodiment could simplify vending machines by removing payment and/or network functionality from the vending machine. Each product in a vending machine could be associated with a separate time-based code series instance.

### Example Computer Systems

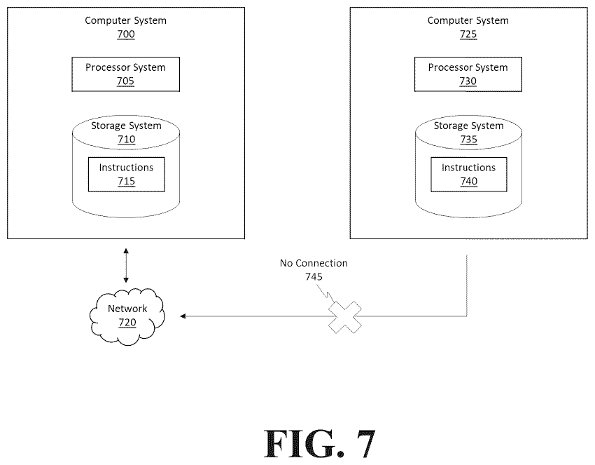

Attention will now be directed to FIG. 7, which illustrates an example computer system 700 that may include and/or be used to perform any of the operations described herein. For instance, computer system 700 can implement service 105 of FIG. 1A.

Computer system 700 may take various different forms. For example, computer system 700 may be embodied as a tablet, a desktop, a laptop, a mobile device, or a standalone device, such as those described throughout this disclosure. Computer system 700 may also be a distributed system that includes one or more connected computing components/devices that are in communication with computer system 700.

In its most basic configuration, computer system 700 includes various different components. FIG. 7 shows that computer system 700 includes a processor system 705 comprising one or more processor(s) (aka a “hardware processing unit”) and a storage system 710.

Regarding the processor(s) of the processor system 705, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 700. The different components, modules, engines, and services described herein may be implemented as objects or processors that execute on computer system 700 (e.g., as separate threads).

Storage system 710 may be physical system memory, which may be volatile, non-volatile, or some combination of the two. The term “memory” may also be used herein to refer to non-volatile mass storage such as physical storage media. If computer system 700 is distributed, the processing, memory, and/or storage capability may be distributed as well.

Storage system 710 is shown as including executable instructions 715. The executable instructions 715 represent instructions that are executable by the processor(s) of the processor system 705 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 700 may also be connected (via a wired or wireless connection) to external sensors (e.g., one or more remote cameras) or devices via a network 720. For example, computer system 700 can communicate with any number devices or cloud services to obtain or process data. In some cases, network 720 may itself be a cloud network. Furthermore, computer system 700 may also be connected through one or more wired or wireless networks to remote/separate computer systems(s) that are configured to perform any of the processing described with regard to computer system 700.

A “network,” like network 720, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 700 will include one or more communication channels that are used to communicate with the network 720. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g., cloud computing, cloud services and the like). In a distributed system environment, program modules may be located in both local and remote memory storage devices.

FIG. 7 also shows a computer system 725 that includes a processor system 730, a storage system 735, and instructions 740. The descriptions pertaining to the processor system 705, the storage system 710, and the instructions 715 equally apply to the processor system 730, the storage system 735, and the instructions 740. Whereas computer system 700 is representative of device 115 of FIG. 1A, the computer system 725 is representative of the lock 140 of FIG. 1A. Notice, the computer system 725 is not connected to the network 720, as shown by no connection 745. Configuring the computer system 725 in this manner allows the battery of the computer system 725 to last for a prolonged time period.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

For the sake of clarity: “code,” “time based code,” and “TOTP” are frequently—but not necessarily always-used interchangeably herein.

### Additional Embodiments (2)

A key code may be submitted/input to a lock in multiple ways. For example, as described herein above, a key code may be input to a lock through button presses (e.g., by a human finger) on a key/button pad on the lock—as shown in FIG. 4. This form of opening requires a user to touch each button sequentially to enter the key code. Time-based key codes (which expire as described herein above), improve security and usability for inputting a key code to a lock. For example, in a system using a time-based key code, the key code may comprise fewer digits/characters/symbols/elements than a persistent (i.e., non-time-based key code) for a similar system; or a time-based key code may use less encryption, or use no encryption at all and still provide secure access. In a system in which a key code is input to a lock through button presses on a key pad or other input device on the lock configured to receive key presses, even short key codes and simple combination secrets expire based on time. This enable devices to remain secure. The architecture described herein—which comprises synchronized time-based (i.e., expiring) key codes—may implement additional methods (alternative to key presses, or in conjunction with key presses) transmit/input the key code to the lock.

Additional methods for inputting/transmitting a key code to a lock may comprise radio communication (Bluetooth, RFID, NFC, WiFi); a sound or audio signal; touch or vibration pattern; light pattern of intensity or contrast); and a sequence/pattern of temperature changes.

In devices using the button press for input of codes described herein, the lock has the necessary electronics and buttons to detect the press(es) comprising input of a key code. To enable other modes of inputting a key code the lock may have a sensor to detect the activation or intensity of each of the specific modes of data transfer.

For vibration or touch an accelerometer may be used. For sound detection, a microphone or other component that detects sound pressure may be used. For light a photo diode or other sensor may be used.

In one embodiment, a key code may be transmitted/input to a lock via Bluetooth. For example, for Bluetooth, numeric characters may have a standard radio signal type that can be used to transmit any unique number, e.g., comprising a key code.

In another embodiment, a key code may be transmitted/input to a lock via RFID (Radio Frequency Identification). For RFID, numeric characters may have a standard radio signal type that can be used to transmit any unique number, e.g., a key code, to a lock.

In another embodiment, a key code may be transmitted/input to a lock via NFC (Near-field Communication). For NFC, numeric characters have a standard radio signal type that can be used to transmit any unique number, e.g., a key code.

In another embodiment, a key code may be transmitted/input to a lock via WiFi. For WiFi, numeric characters may have a standard radio signal type that can be used to transmit any unique number, e.g., a key code.

In another embodiment, a key code may be transmitted/input to a lock via sound or audio signals. For example, for audio it may be possible to use morse-code type of encoding of a key code comprising with long and short tone inflection or sound pulses.

In another embodiment, a key code may be transmitted/input to a lock via light signals (e.g., optical and/or electromagnetic) or pulses. For example, a device may transmit the key code through a light pulse, e.g., pulsing the flashlight or similar feature on a smartphone. In one embodiment, morse code or a similar system may be used to encode a light pulse as a key code.

In another embodiment, a key code may be transmitted/input to a lock via force/vibration. For example, a device code may transmit the key code through a sequence of force/vibration pulses, e.g., pulsing the vibration feature on a smartphone. In one embodiment, morse code or a similar system may be used to encode a force/vibration pulse sequence as a key code.

In one embodiment, a key code may be transmitted to the lock from a smartphone using pulses from visible and/or non-visible parts of the electromagnetic spectrum. In this embodiment, the smartphone would be enabled with the necessary hardware and software to transmit the electromagnetic signal, and the lock would be enabled with the necessary hardware and software to receive the electromagnetic signal.

In one embodiment, a key code may be transmitted to the lock from a smartphone using a sequence or pattern of temperature changes emitted from or otherwise provided by a smartphone or other device. In this embodiment, the smartphone would be enabled with the necessary hardware and/or software to emit or provide a changing temperature pattern, and the lock would be enabled with the necessary hardware and/or software to sense and receive the temperature sequence or pattern.

In one embodiment, the lock may broadcast a lock id using one or more of the communication technologies described herein above for transmitting a key code to the lock, e.g., Bluetooth, RFID, NFC, WiFi, vibration/audio/sonic, and/or electromagnetic emissions. The lock may continuously broadcast the lock id, or may broadcast the lock id only when “woken up,” e.g., by a button press or other input, or triggered in some other way. Broadcasting may enable a smartphone or other electronic device to receive and become aware of the lock id and to therefore select a key code associated with the lock and/or a technology for transmitting the key code to the lock.

Some or all of the technologies described herein above for transmitting a key code from a smartphone (or other electronic device) to a lock may be implemented using one-way communication technologies or implementations that are one-way or do not require handshaking or other overhead for two-way communication. This may simplify the communications/transmissions and the hardware/software in the lock and/or smartphone necessary for implementing such one-way communications.

For lock embodiments described herein above that do not require a keypad for receiving a key code, such locks may or may not comprise a keypad on or as part of the lock. In some embodiments, a lock configured to receive a key code through a wireless technology (e.g., RFID, NFC, WiFi, sound/audio signal, touch/vibration pattern, light pattern, temperature pattern, etc.) may not have a keypad, or may have a limited number of keys for received keys and/or configuration/management. A lock may be configured to receive a key code in multiple ways, e.g., both keypad and RFID.

What is claimed is:

1. An access control system, comprising:
an access management server;
an access control device that is physically remote from the access management server;
a first time-based code series instance, comprising:
a shared seed code that is known to both the access management server and to the access control device;
a time-based code generation algorithm that is known to both the access management server and to the access control device;
an access control device clock that is synchronized to an access management server clock; and
a time-based code generation schedule that is known to both the access management server and to the access control device, wherein (i) the time-based code generation schedule comprises a set of time periods wherein each time period is associated with a clock begin value and a clock end value (which could be the same); and (ii) the set of time periods may be based on an algorithm for generating time periods based on an input clock value; and
non-transitory computer executable instructions that are stored at the access control device and that, when executed, cause the access control device to:
receive an input time-based code;
generate a generated time-based code from the time-based code series instance using (i) a current clock value from the access control device clock and (ii) the time-based code generation schedule;
compare the input time-based code with the generated time-based code;
determine that the input time-based code matches the generated time-based code; and
based on the match between the generated time-based code and the input time-based code, perform an action;
wherein receiving an input time-based code comprises receiving an input time-based code at least in part via at least one from the following list:
radio frequency identification (RFID);
Bluetooth;
near-field communication (NFC);
WiFi;
audio signal;
vibration pattern;
light pattern; and
temperature pattern.

2. The access control system of claim 1, further comprising:
a code-check algorithm comprising at least one of the following:
a second time-based code series instance; and
a configuration code instance.

3. The access control system of claim 1, wherein receiving an input time-based code comprises receiving an input time-based code at least in part via RFID.

4. The access control system of claim 1, wherein receiving an input time-based code comprises receiving an input time-based code at least in part via Bluetooth.

5. The access control system of claim 1, wherein receiving an input time-based code comprises receiving an input time-based code at least in part via NFC.

6. The access control system of claim 1, wherein receiving an input time-based code comprises receiving an input time-based code at least in part via WiFi.

7. The access control system of claim 1, wherein receiving an input time-based code comprises receiving an input time-based code at least in part via audio signal.

8. The access control system of claim 1, wherein receiving an input time-based code comprises receiving an input time-based code at least in part via vibration pattern.

9. The access control system of claim 8, wherein the vibration pattern is produced by a smartphone vibration functionality.

10. The access control system of claim 1, wherein receiving an input time-based code comprises receiving an input time-based code at least in part via light pattern.

11. The access control system of claim 1, wherein receiving the light pattern is produced by a smartphone flash light.

12. The access control system of claim 1, wherein receiving an input time-based code comprises receiving an input time-based code at least in part via temperature pattern.

13. The access control system of claim 1, wherein performing an action comprises granting access to a resource.

14. The access control system of claim 11, wherein granting access to a resource comprises granting access to the resource for a period of time.

15. The access control system of claim 1, wherein the first time-based code series instance is associated with a first user.

16. The access control system of claim 2, wherein:
the code-check algorithm comprises a second time-based code series instance;
the second time-based code series instance comprises:
a second shared seed code that is known to both the access management server and to the access control device;
a second time-based code generation algorithm that is known to both the access management server and to the access control device;
a second access control device clock that is synchronized to a second access management server clock; and
a second time-based code generation schedule that is known to both the access management server and to the access control device, wherein (i) the second time-based code generation schedule comprises a set of time periods wherein each time period is associated with a clock begin value and a clock end value (which could be the same); and (ii) the set of time periods may be based on an algorithm for generating time periods based on an input clock value; and
the non-transitory computer executable instructions stored at the access control device further comprise instructions that, when executed, cause the access control device to:
receive an input time-based code;
generate a generated time-based code from the time-based code series instance using (i) a current clock value from the access control device clock and (ii) the time-based code generation schedule;
compare the input time-based code with the generated time-based code;
determine that the input time-based code does not match the generated time-based code;
compare the input time-based code with a second generated time-based code generated from the second time-based code series instance using (i) a current clock value from the second access control device clock and (ii) the second time-based code generation schedule; and
based on the match between the second generated time-based code and the input time-based code, perform a second action.

17. The access control system of claim 15, wherein performing a second action comprises granting access to a resource.

18. The access control system of claim 15, wherein performing a second action comprises granting access to a resource for a second period of time that is different from the first period of time.

19. The access control system of claim 15, wherein the second time-based code series instance is associated with a second user.

20. The access control system of claim 1, wherein:
the code-check algorithm comprises a configuration code instance;
the configuration code instance comprises:
a configuration code known by the access control device;
non-transitory computer executable instructions that are stored at the access control device and that, when executed, cause the access control device to:
receive an input code;
compare the input code to the configuration code;
based on a determination that the input code matches the configuration code, perform a configuration action.
